(19) United States
(12) Patent Application Publication
(10) Pub. No.: US 2016/0026633 A1
(43) Pub. Date: Jan. 28, 2016

(54) DEVICES, SYSTEMS AND METHODS FOR RENDERING, UPDATING AND COMMUNICATING RELATIONSHIP INFORMATION

(71) Applicant: KELVIN INC., Portola Valley, CA (US)

(72) Inventors: Peter HARDING, Portola Valley, CA (US); Adam GUETZ, Mountain View, CA (US); Peter ALPERIN, San Francisco, CA (US)

(73) Assignee: KELVIN INC., Portola Valley, CA (US)

(21) Appl. No.: 14/340,441

(22) Filed: Jul. 24, 2014

(51) Int. Cl. G06F 17/30; H04L 29/06; G06F 3/0484

(52) U.S. Cl. CPC G06F 17/3053; G06F 3/04842; H04L 65/403; G06F 17/30867; G06F 17/30876

(57) ABSTRACT

A computer server coupled to a computer network comprises a network adaptor configured to communicate at least with social media information sources and other data sources over a computer network; a processor coupled to the network adaptor and memory coupled to the processor. The memory stores a program configured to cause the processor to receive social interaction information from at least one remote computing device over the computer network; rank the received social interaction information according to at least one metric that is selectable by a user of a computing device coupled to the computer server over the computer network; and send the ranked social interaction information to the computing device to be rendered on a display thereof such that higher-ranked social interaction information is displayed closer to a center of concentric shapes rendered on the display of the computing device than is comparatively lower ranked social interaction information.

### BACKGROUND

Social interaction information from sources such as Facebook, Apple, Google, Twitter, Instagram and others play an increasingly important role in daily life. While such services can bring people together and enhance interpersonal relationships, they can also paradoxically contribute to feelings of isolation, social compartmentalization and disconnectedness. Indeed, while providing valuable information, such services often do not promote or facilitate serendipitous in-person, face-to-face meetings, physical interactions or a more complex and nuanced view of personal and professional relationships.

### BRIEF DESCRIPTION OF THE DRAWINGS

FIG. 1 is a block diagram of a system according to one embodiment.

FIG. 2 is an exemplary view of elements of a user interface (UI) according to one embodiment.

FIG. 3 is another exemplary view of elements of a user interface according to one embodiment

FIG. 4 is still another exemplary view of elements of a user interface according to one embodiment.

FIG. 5 is yet another exemplary view of elements of a user interface according to one embodiment.

FIG. 6 is a view of an exemplary user interface and process by which a user may define and refine the views presented, according to one embodiment.

FIG. 7 is a flowchart of a computer-implemented method according to one embodiment.

FIG. 8 is a block diagram of a computing device (e.g., desktop computer, mobile device, tablet, server) with which embodiments may be practiced.

### DETAILED DESCRIPTION

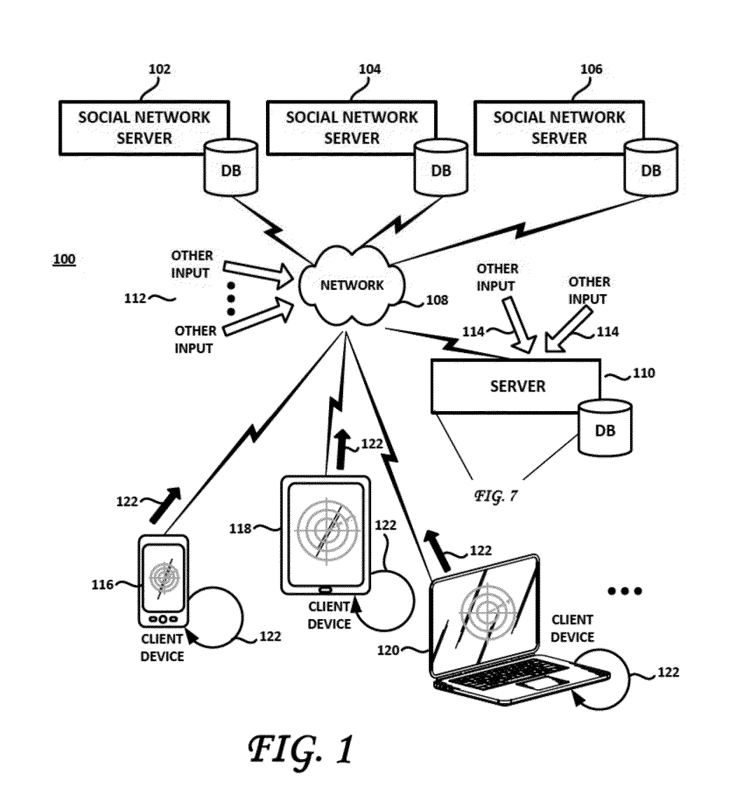

FIG. 1 is a block diagram of a system 100 according to one embodiment. As shown therein, a computer server 110 may be coupled to a computer network 108. The computer network may comprise, for example, one or more private or public, networks such as the Internet. The computer server may comprise a network adapter configured to communicate with other information sources such as social media servers 102, 104, 106 over the network 108. The social media servers may be thought of as some of the possible sources of social interaction information and may comprise, for example, Facebook® servers, Twitter® servers, Instagram®, RenRen®, LinkedIn®, YouTube®, Vine®, Vimeo® and/or any other sources of public. and private information, whether currently characterized as “social data” or “social media” servers or not Other source of (social interaction, personal) information include wearables such as FitBit® and Jawbone®, mobile phone location services and or other services such as GitHub® and Google services. Each of the social interaction sources may have databases coupled thereto from which the servers may draw to service, access requests from users over the computer network 108. As shown at 112 and 114, the computer server 110 may also draw from other information sources 112, 114 such as, for example, news sources, weather sources, entertainment sources and/or, as will be detailed below, source of enterprise information. The computer server 110 may also be coupled to a database from which it ma draw to service requests from client devices 116, 118, 120 Such client, devices may comprise mobile devices such as mobile phones, tablets, or laptop computers 120 and the like.

According to one embodiment, the computer server 110 may further comprise one or more processors coupled to the network adaptor and memory coupled to the processor. The memory (whether volatile and/or non-volatile) may he configured to store one or more computer programs configured to cause the processor to carry out functionality detailed herein. According to one embodiment, the computer server 110 may receive social interaction information from one or more remote computing devices (including, for example, social media servers 102, 104, 106 and/or other input sources 112, 114) over the computer network 108. The received social interaction information may then be ranked according to one or more metrics that are selectable by a user of as computing device (such as, for example, client computing devices 116, 118, 120) coupled to the computer server 110 over the computer network. The received social interaction information may also originate from other sources, such as the client computing devices themselves, as suggested at 122, whether such information is auto-generated by the device itself or from entries by the user thereof For example, location information that specifies the current and past location of the client computing device 116, 118 or 120 may also be ranked according to the user-selectable metrics. Other client computing device-generated data (behavioral-related, health-related, temporal-related (e.g., time-stamps) and the like) may also be received by the computer server 110 for ranking and/or used and ranked internally within the client computing device 116, 118 or 120. Other sources of data may also be leveraged, as those of skill may recognize. Still further information may be received from other information sources, such as news-gathering organizations, educational institutions, governmental organizations, businesses, data aggregators and the like. Collectively, all such sources of information are herein referred to as “social interaction information”. The ranked social interaction information may then be sent to one or more computing devices to be rendered on a display thereof such that higher-ranked social interaction information is displayed closer to a center of concentric circles rendered on the display of the computing device than is comparatively lower-ranked social interaction information, as shown in subsequent figures.

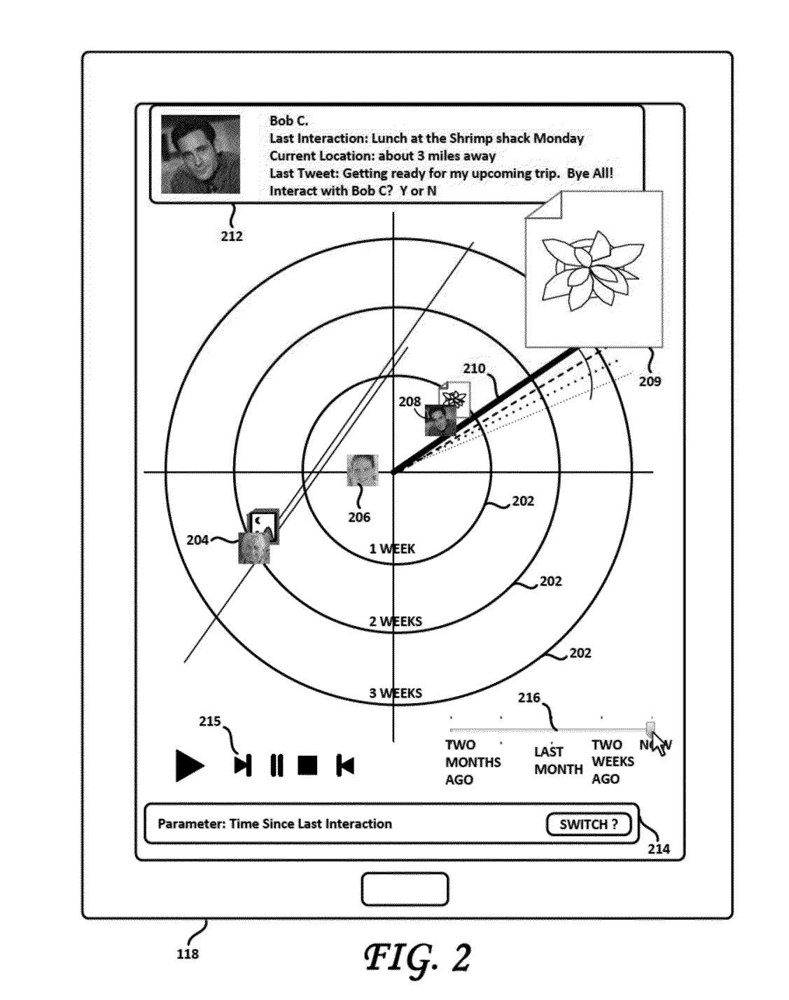

FIG. 2 is an exemplary view of elements of a user interface according to one embodiment. The user interface is shown on a display of a tablet computer 118. However, it is to be understood that the functionality, user interface and steps disclosed herein may be adapted to function on most any computing device. One embodiment causes a series of concentric shapes 202 to be rendered on a display of the computing device. In the figures and hereinafter, such concentric shapes are shown and referred to herein as concentric circles. However, it is to be understood that embodiments are not be limited thereby and that most any suitable concentric shapes may be substituted for the concentric circles shown herein. For example, concentric octagons or higher or lower-order polygons may be used to good advantage herein without loss of functionality or aesthetic value. Similarly, while only three concentric circles are shown and described herein, a lesser or greater number of circles may be rendered, depending upon the desired granularity of the rendering and/or depending upon the available specificity of the received social interaction information. Indeed, the number of concentric circles for other shapes) may be static or dynamic in nature. If dynamic, the number of concentric circles may be varied depending, for example, whether the received social interaction information allows such tine-grained distinctions along the user-selected metric or metrics.

As shown, the concentric, shapes 202 may be configured to provide, to the user of the device 118, the received social interaction information (and/or information from other another source or sources), which may be ranked (at the server 110 and/or at the client device 118) according to one or more user-selectable metrics. In the implementation shown in FIG. 2, the user-selectable metric or parameter is “Time Since Last Interaction”. Note that this metric or parameter may also have been selected by an entity other than the user of the device 118 such as, for example, by server 110. The ranked social interaction information (and/or other) information may then be rendered on, or within over overlaid on the concentric shapes 202. The received information may, be rendered as graphic. representations that are indicative of the origination of the social interaction information. For example, the graphic representation may comprise, for example, a photo of a person or entity that is associated with the received social interaction information. The graphic (or other, such as textual) representation may also comprise a corporate logo or most any identifier with which the user of the client device 118 has formed a personal and/or professional association.

In this Time Since Last Interaction implementation, the position of the graphic representations 204, 206, 208 are indicative of the time since the user of the device 118 last interacted with the person or entity represented by the graphic representation. For example, the user of the device 118 may have interacted with Alice, as represented by graphic representation 206 and Bob, as represented by graphic. representation 208, less than a week ago, as the graphic representations 206, 208 have been disposed within the innermost concentric shape 202. The user of the device 118, on the other hand, may have last interacted with Charlie, as represented by graphic representation 204, fully two weeks ago, as the graphic representation 204 has been rendered straddling the middle concentric shape 202. In this manner, when the ranking is carried out based upon a Time Since Last Interaction metric, higher-ranked social interaction information (e.g. Alice 206 and Bob 208) may be displayed closer to the center of concentric circles rendered on the display of the computing device than comparatively lower-ranked social interaction information (e.g., Charlie 204). According to one embodiment, the angular separation between graphic representations may be coded as, for example, the similarity between rankings and/or on some other user or programmatically-selectable criteria or parameter. For example, graphic representations sharing about the same distance from the center of the concentric shapes 202 may be disposed and clustered in different quadrants depending on, for example, user-defined separations such as school, work, club affiliation, romantic interest, hobbies and/or most any other affiliation. Those of skill may recognize other possibilities and all such are deemed to be within the purview of the present disclosure.

The graphic representations, according to one embodiment, may be simple graphic representations: they may be mere pictures that do not allow interactivity. However, one embodiment may imbue the graphic representations as shown at 204, 206, 208 with predetermined functionality. For example, the graphic representations may be active elements that enable the user to touch or click thereon to bring up additional information regarding the person or entity associated with the graphic representation and/or allow the user of the device 118 to interact with that person or entity in some manner. For example, touching or clicking the graphic representation may bring up updates from that person or entity, their current location, details of the last interaction the user of the device 118 had with that person or entity and/or any combination thereof. Alternatively, such updates may be rendered automatically or in turn on the device 118 by, for example, a sweeping device 210 that pivots about the center of the concentric shapes 202.

One embodiment includes a chat client built in to the application embodying the functionality shown and described herein that allows users to have one-on-one or group conversations without leaving the application. The chat client may be configured to enable one-on-one or group chats, to select from among, those users whose graphic representations are or have been shown, to enable the uploading of content to the chat group. One embodiment enables a chat history to be completely deleted (i.e., irrevocably wiped) from a user's device and from the devices of all who may have received the content in question.

Reference numeral 212 shows one possible implementation of such updates. At 212, FIG. 2 shows updates from Bob C. whose graphic representation 208 was swept by sweeping device 210 and/or touched or clicked by the user of the device 118. Such updates 212 may comprise, for example, a date, time and/or occasion at which the user of the device 118 last interacted with this person, a current location of Bob C and a last social media entry (such as a Tweet, for example). Many other updates regarding Bob C may be provided, subject to appropriate security and privacy settings of both the user of the device 118 and the person or entity whose updates are rendered at 212. Such updates may also be subject to configurable preferences, so as to enable the user of the device 118 to customize his or her experience. One embodiment enables the user of the device 118 to decide whether he or she wishes to interact with the subject. (Bob C. in the example being developed herewith) of the update 212. If the user chooses to so interact, Bob C's Facebook page, Twitter feed, Instagram or other social media manifestation may be brought up, to enable the user of the device 118 to interact therewith. Other was of interacting with Bob C may be devised. The updates 212 may be more or less persistent, as configured by, for example, the user of the device 118,

As the user of the device 118 interacts with new of previously-displayed persons or entities, the presence or position of the graphic representations thereof within the concentric shapes 202 may be updated. For example, if the user is active on social data and the scale of the Time Since Last Interaction may be diminished from the displayed weeks to minutes, (e.g., within the last 5 minutes for the inner most concentric shape 202, within the last 10 minutes for the middle concentric shape 202 and within the last 15 minutes for the outer-most concentric shape 202), the display may become quite dynamic and fluid and particularly attractive to younger users.

Video controls 215 may be provided to control the sweep of sweeping device 210, as it rotates around the concentric shapes and causing updates 212 to appear as it touches each graphic representation 208, 206, 204 in turn. Pause, Stop, Fast Forward, Rewind, Return to the beginning and skip to the end controls may be provided. As shown at 216, other controls may be provided to further customize the user experience. As historical data is kept by many social media sites and other sources of social interaction information, and by, according to one embodiment, server 110, the user may be provided with the ability to “rewind” the display shown in FIG. 2 to show an earlier time such as for example, two weeks ago, last month or two months ago, by simply sliding a slide bar to the left. Historical information may then be requested from the social media servers 102, 104, 106 and/or from the server 110 and the display updated to the state it was or would have been two weeks, ago, last month or two months ago, depending upon the user's selection at 216.

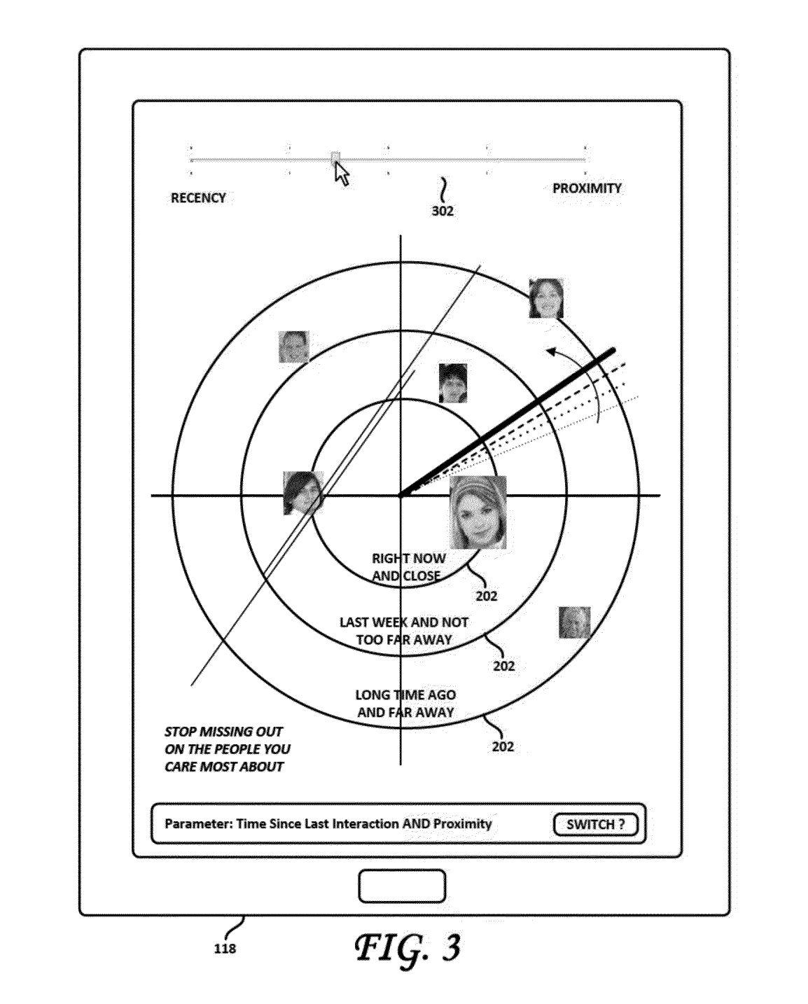

Other information may be tagged, associated or attached to the graphic representations 204, 206 or 208 such as pictures or videos. For example, Bob C's graphic representation 208 may be rendered together with a thumbnail of a picture 209, which may be displayed for the user upon demand, as shown at 209. Other functionality may be provided and activated upon demand or upon occurrence of a predetermined event (such as being within 100 feet of the person or entity associated with a displayed graphic representation, for example). According to one embodiment, the user of the device 118 may upload audio or visual content and select, from among those whose graphic representations are shown within the concentric shapes, those with whom the user wishes to share the uploaded content. Finally, as shown at 214, the user may be provided with the ability to switch the metric or parameter from the current Time Since Last Interaction to some other metric(s), as illustrated in FIG. 3.

The received social interaction, social media-related or other information may be ranked and displayed according to two or more metrics. In the example shown relative to FIG. 3, the selected metrics are Time Since Last interaction and Proximity. In this manner, the graphic representations shown overlaid on the concentric shapes 202 may be organized according to both Time Since Last interaction and their current Proximity to the user of the client device 118. According to one embodiment, a user-selectable weight or coefficient may be associated with each of the metrics, which enables the user to influence the ranking and rendering of the social interaction information on the concentric circles on the display. Such may be selected by the user using a slider or other UI tool, as shown at 302. By sliding the slider closer to Recency, as shown, the user indicates that he or she prefers a display in which Time Since Last Interaction using a Facebook or Twitter timestamp, for example) has relatively more effect upon the ranking than does Proximity. Conversely, by sliding the slider closer to Proximity, as shown, the user indicates that he or she prefers a display in which Time Since Last Interaction has relatively less effect upon the ranking than does Proximity. Other mechanisms for customizing the view presented to the user may readily be provided.

As shown in FIG. 3, the appearance of the graphic representations may be varied depending upon. most any factor. For example, graphic representation 304 is shown to be comparatively larger than the other graphic representations, which may be indicative of a top ranking and/or some other attribute, such as membership in a selected group of friends, for example.

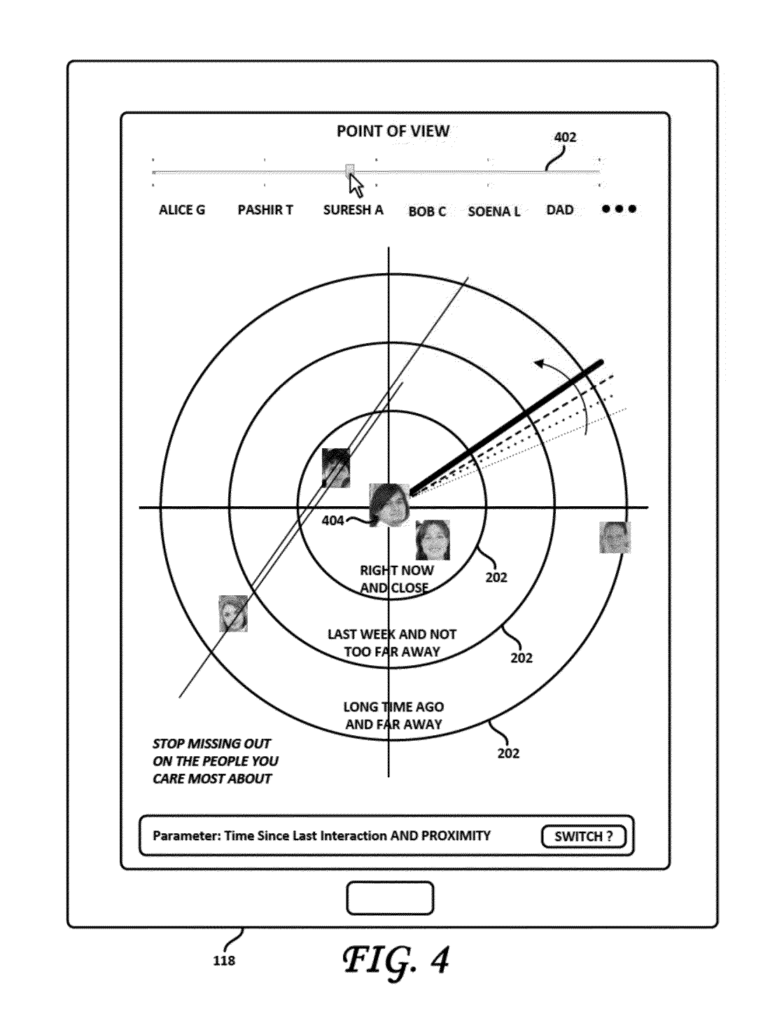

FIG. 4 shows another embodiment. In FIG. 4, slider 402 may be provided to enable the user of the device 118 to switch points of view. Indeed, in FIGS. 2 and 3. the concentric shapes and the graphic representations are provided as if the user of the device 118 were at the geometric center of the concentric circles 202. Such a literally self-centered display would have the user located at the center of the concentric shapes 202, with larger shapes 202 centered on him and extending radially outward. That may be the user's normal, default point-of-view, which enables him or her to see, at a glance, who (or what entity(ies)) is/are both close to him right now and with whom he has most recently interacted. The slider 402, however, enables the user to switch to another's point-of-view. For example, in FIG. 4, the user of the device 118 has moved the slider to indicate that he or she wishes the rendering to update such that her friend Suresh A is at the center of the concentric circles 202, as shown at 404. The displayed graphic representations would then be updated to show the user of the device 118 which persons and/or entities are currently closest to Suresh A and with whom Suresh A has most recently interacted subject, again, to appropriate setting, security and permissions. in this manner, the social interaction information (and/or other) may be ranked for rendering on the display as if the user of the computing device 118 were at the center of the concentric circles or shapes 202. Alternatively and as shown in FIG. 4, the social interaction (and/or other) information for rendering on the display as if a social media user other than the user of the computing device 118 were at the center of the concentric circles or shapes 202.

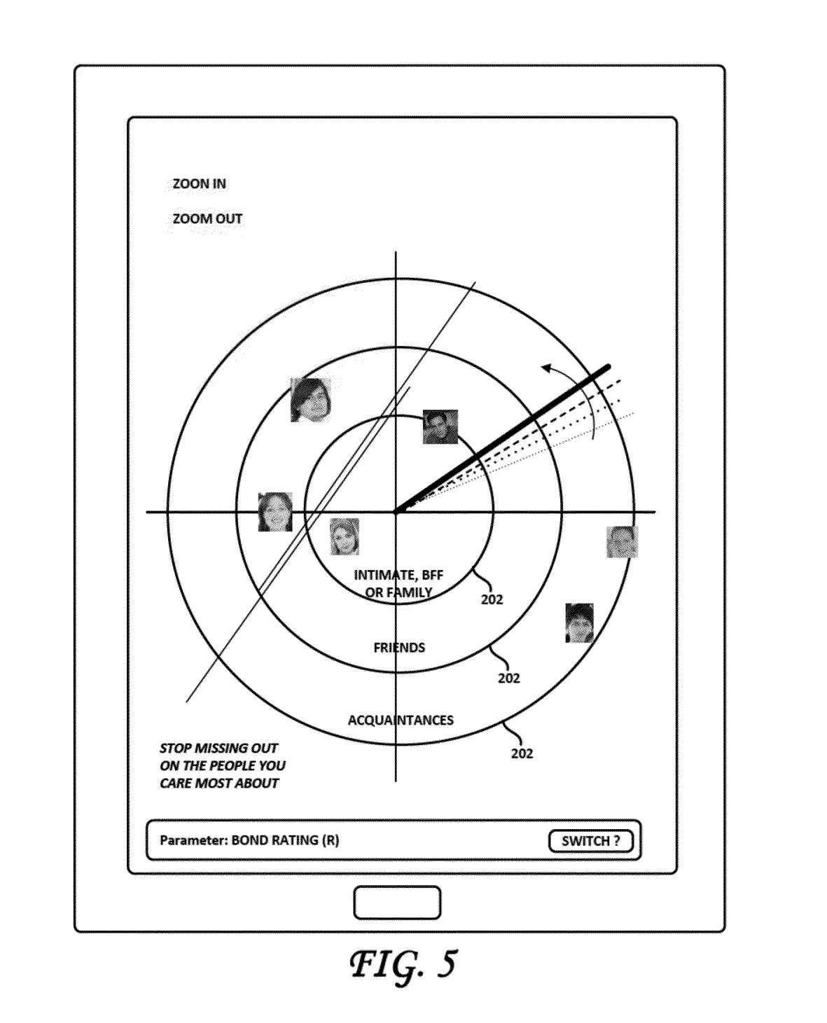

FIG. 5 is yet another exemplary view of elements of a user interface according to one embodiment. As shown therein, the graphic representations (or other placeholders for social interaction and/or other information) may be ranked and rendered on or overlaid over the concentric shapes 202 according to the strength of the personal bonds between the displayed individuals or entities. According to one embodiment the determined, calculated, computed or otherwise extrapolated strength of the personal relationships between individuals may be ranked and rendered on the concentric shapes 202 such that, for example. those having the strongest Bond Rating™ are shown closest the common center of the concentric shapes 202 with those having comparatively lower Bond Ratings™ being rendered comparatively further away from the common center. The Bond Rating™ between individuals or entities may he determined subjectively by the user and/or programmatically. For example, the Bond. Rating™ between two individuals may be determined at least in part information indicative of a time since a last interaction; frequency of interaction, confluence of interests, hobbies and jobs, the quality of communications between them (short casual utterances versus richly textured communications) interaction with common content, social activity, news, location and most any factor, metric or indicator that connects one individual to another individual or entity or that connects one entity (e.g., a clothing store, for example) with another entity or natural person.

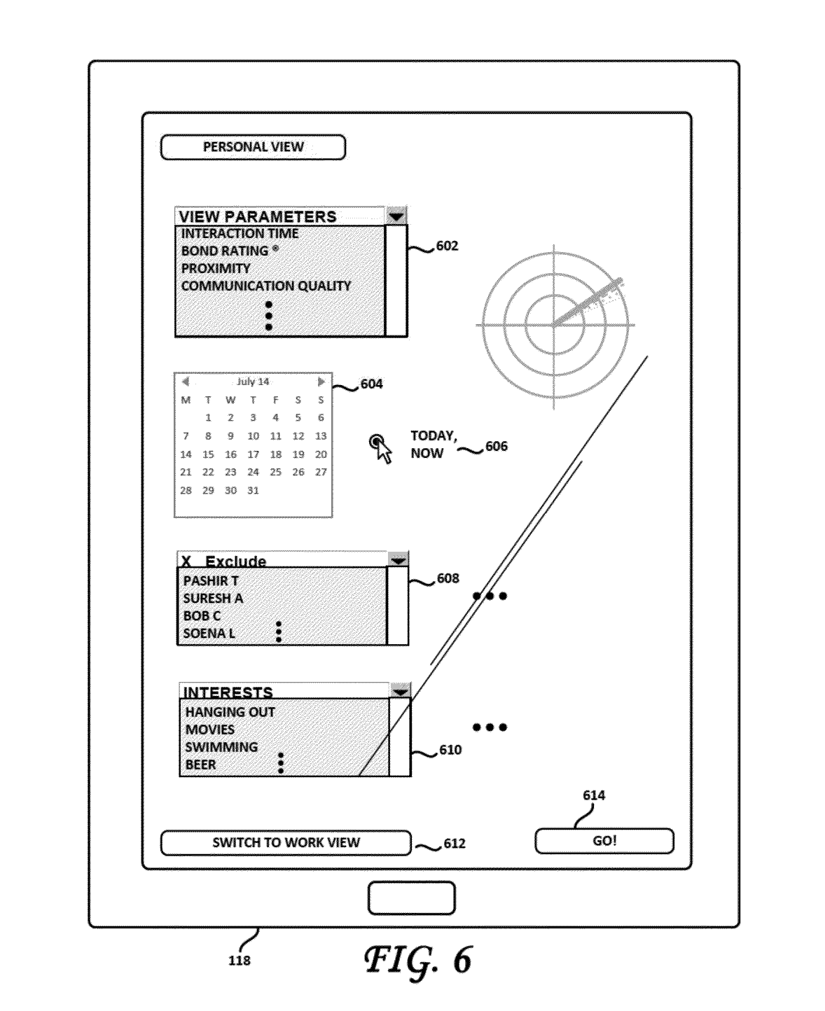

FIG. 6 is a view of an exemplary user interface and process by which a user may define and refine the views presented, according to one embodiment. As shown therein, a “Settings” page may be provided to enable the user of the device 118 to determine what is to be displayed on the concentric shapes 202 and the manner in which the information is presented. For example, the user may be presented with a View Parameters drop-down menu 602. The drop-down menu 602 may present the user of the device 118 with a number of choices by which to rank and render the social interaction information or other information. For example, choices such as “Interaction Time”, “Bond Rating™”, “Proximity”, “Communication Quality” and the like may be selected and used to rank and render the social interaction information. Other choices may be presented in a format other than a drop-down menu, as those of skill in this art may recognize. The information presented may be the very latest information available by selecting the “Today. Now” radio button 606 or the device 118 may be configured to render the social interaction information (and/or other) information as of some specified date in the past, using, for example, a calendar 604. UI devices for excluding one or more persons or entities from having their graphic representations rendered on the concentric shapes 202 may also be provided, as shown at 608. Also, as shown at 610, various filters may be applied to the ranked social interaction information, to cause the device 118 to preferentially rank and display those having specific interests such as hanging out, movies, swimming and/or beer, for example. For example, selecting “Hanging Out” may cause that or those individuals having expressed a like desire to be highlighted on the display, thereby enabling the user of the device 118 to connect with currently like-minded persons. When all desired metrics have been selected, the user may configure his or her display accordingly by touching or otherwise selecting the “Go” button 614 or functionally similar UI element.

Shown and described thus far are views that show personal relationships and generally non work-related information. According to one embodiment, however, parameters, criteria and metrics related to the user's work environment or job may be selected and used for ranking and displaying enterprise-related information on the device 118. for example, the concentric shapes 202 may denote sales territories and the graphic representations may denote current or prospective sales opportunities, persons in need of immunizations or other aid. The rendering of the graphic representations may be changed as needed, to display those entities having purchased the most product or services over the last twelve months, competitors and the like. Data for populating the concentric shapes 202 in an enterprise-related implementation may come from news aggregators, paid online databases, the user's employer's databases and/or most any source of relevant business information. The same abilities as described relative to the personal version may be made available to the enterprise or professional version such as, for example, the ability to rewind, shift point of view, get real time business intelligence and the like. The ability to accurately, simply and fluidly display business (e.g., sales team management, sales team target and the like) information using the concentric shapes and functionalities described and shown herein provides an intuitively understandable and powerful tool to the business or service aid professional.

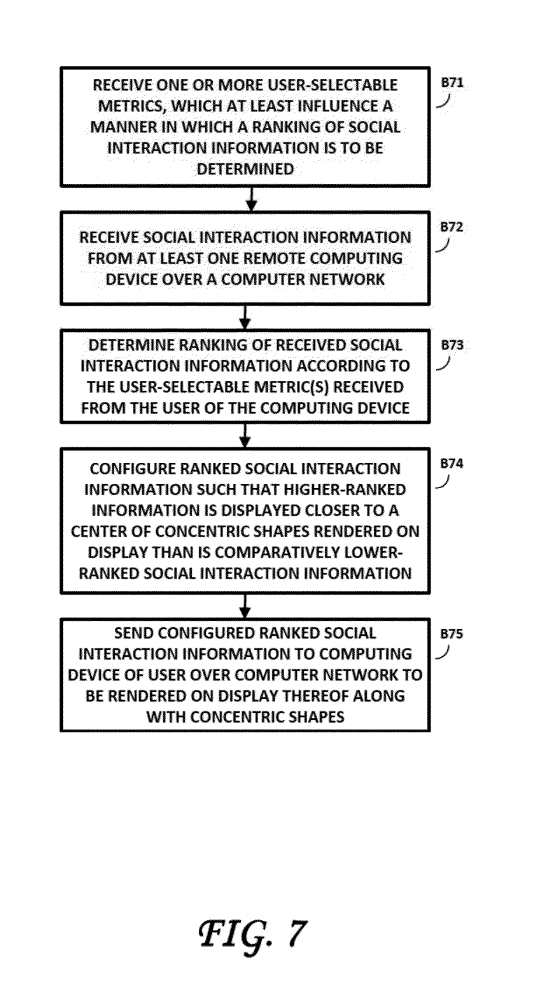

FIG. 7 is a flowchart of a computer-implemented method according, to one embodiment. As shown, block B71 calls for receiving (at server 110 in FIG. 1, for example) one or more user-selectable metrics from a user of a computing device coupled to a computer network. The received metric(s) may be configured, according to one embodiment, to at least influence (or determine) the manner in which a ranking of social interaction information is to be determined. Block B72 calls for receiving, the social interaction information from one or more remote computing devices (e.g., servers 102, 104, 106) over the computer network 108. At B73, the ranking of the received social interaction information may be determined according to the user-selectable metric(s) received from the user of the computing device. Then, the ranked social interaction information to be rendered on a display of the computing device may be configured as shown at B74 such that higher-ranked social interaction information is displayed closer to a center of concentric shapes (e.g., circles) also rendered on the display of the computing device than is comparatively lower-ranked social interaction information. Block B75 then calls for sending the configured ranked social interaction information to the computing device of the user over the computer network to be rendered on the display thereof along with the concentric circles, for rendering thereon, as shown at FIGS. 2-5.

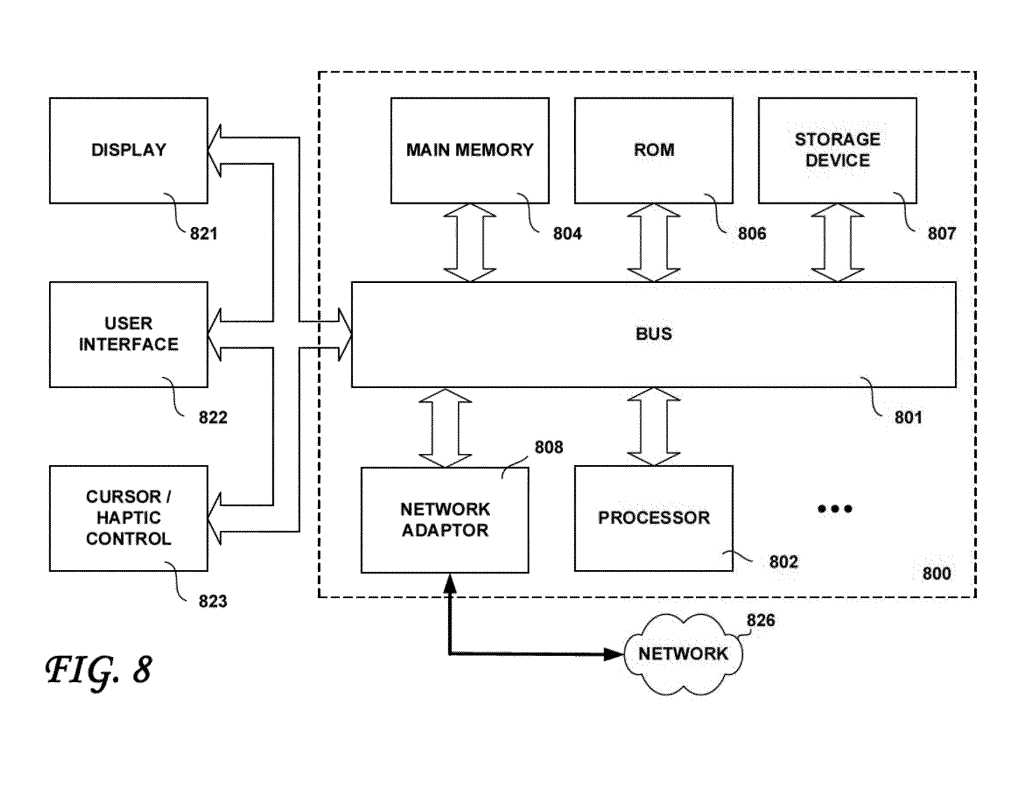

FIG. 8 is a block diagram of a computing device or system (e.g., desktop computer. mobile device, tablet, server) with which embodiments may be practiced. For example, the architecture shown in FIG. 8 may be present in the servers 102, 104, 106, server 110 configured to carry out an embodiment, as well as client devices such as shown at 116, 118 and 120 in FIG. 1. Computer system 800 includes a bus 801 or other communication mechanism for communicating information, and one or more processors 802 coupled with bus 801 for processing information. Computer system 800 further comprises a random access memory (RAM) or other dynamic storage device 804 (referred to as main memory), coupled to bus 801 for storing information and instructions to be executed by processor(s) 802. Main memory 804 also may be used for storing temporary variables or other intermediate information during execution of instructions by processor 802. Computer system 800 also includes a read only memory (ROM) and/or other static storage device 806 or non-volatile memory 806 coupled to bus 801 for storing or persistent static information and instructions for processor 802. A data storage device 807, such as a magnetic disk and/or solid state storage, may be coupled to bus 801 for storing information and instructions. The computer system 800 may also be coupled via the bus 801 to a display device 821 for displaying information to a user. A user interface device 822, including alphanumeric and other keys, may be coupled to bus 801 for communicating information and command selections to processor(s) 802. Another type of user input device is cursor or haptic control 823, such as a touch screen, mouse, a trackball, or cursor direction keys for communicating direction information and command selections to processor 802 and for controlling cursor movement on display 821, A network adaptor 808 may also be coupled to the bus 801 to enable the computer system 800 to communicate with, for example, the servers 102, 104, 106 over the computer network 826 to achieve the functionalities shown and described herein.

Portions of the detailed description herein describe processes and symbolic representations of operations by computing devices that may include conventional computer components, including a local processing unit, memory storage devices for the local processing unit, display devices, and input devices. Furthermore, such processes and operations may utilize conventional computer components in a heterogeneous distributed computing environment including, for example, remote file servers, computer servers, and memory storage devices. These distributed computing components may be accessible to the local processing unit by a communication network such as shown at 108 and 826. The processes and operations performed by such computing, devices include the manipulation of data bits by a local processing unit and/or remote server and the maintenance of these bits within data structures resident in one or more of the local or remote memory storage devices. These data structures impose a physical organization upon the collection of data bits stored within a memory storage device and represent electromagnetic spectrum elements. A process or computer-implemented method may generally be defined as comprising a sequence of computer-executed steps leading to a desired result. These steps generally require physical manipulations of physical quantities. Usually, though not necessarily, these quantities may take the form of electrical, magnetic, or optical signals capable of being stored, transferred, combined, compared, or otherwise manipulated. It is conventional for those skilled in the art to refer to these signals as bits or bytes (when they have binary logic levels), pixel values, works, values, elements, symbols, characters, terms, numbers, points, records, objects, images, files, directories, subdirectories, or the like. It should be kept in mind, however, that these and similar terms should be associated with appropriate physical quantities for computer operations, and that these terms are merely conventional labels applied to physical quantities that exist within and during operation of the computer.

It should be understood that manipulations within the computer are often referred to in terms such as adding, comparing, moving, positioning, placing, illuminating, removing, altering, etc., which are often associated with manual operations performed by a human operator. The operations described herein are machine, programmatic operations performed in conjunction with various input provided by a human operator or user that interacts with the computer. The machines used for performing the operation of the present invention include local or remote general-purpose digital computers or other similar computing devices. in addition, it should also he understood that the programs, processes, methods, etc. described herein are not related or limited to any particular computer or apparatus nor are they related or limited to any particular communication network architecture, Rather, various types of general-purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

1. A mobile computing device, comprising:
a network adaptor configured to communicate with social media sites and other sources of behavioral data over a computer network;
a processor coupled to the network adaptor;
a display coupled to the processor;
memory coupled to the processor, the memory storing a program that is configured to cause the processor to:
cause a series of concentric shapes to be rendered on the display;
receive social interaction information from at least one remote computing device over the computer network;
rank, if the received social interaction information is not already ranked, the received social interaction information according to at least one metric that is selectable by a user of the mobile device; and
cause the ranked social interaction information to be rendered on the display such that higher-ranked social interaction information is displayed closer to a center of the concentric shapes than is comparatively lower-ranked social interaction information.

2. The mobile device of claim 1, wherein the social interaction information rendered on the display comprises graphic representations of social media users that are ranked and rendered on the display such that the graphic representations of social media users that have interacted with the user of the mobile device more recently are rendered closer to the center of the concentric shapes than are the graphic representations of social media users that have interacted with the user of the mobile device comparatively less recently.

3. The mobile device of claim I wherein the processor is further configured to rank the received social interaction information according to two or more metrics.

4. The mobile device of claim 3, wherein the processor is further configured to associate a user-selectable weight coefficient to each of the two or more metrics, thereby enabling the user to influence a ranking and rendering of the received social interaction information on the concentric shapes on the display.

5. The mobile device of claim 1, wherein the processor is further configured to render the ranked social interaction information on the display as if the user of the mobile device were at the center of the concentric shapes.

6. The mobile device of claim 1, wherein the processor is further configured to render the ranked social interaction information on the display as if a social media user other than the user of the mobile device were at the center of the concentric shapes.

7. The mobile device of claim 1, further comprising animating the displayed social interaction information and wherein additional information is dynamically and selectively available on each of the social media users whose graphic representations are rendered on the display.

8. The mobile device of claim I, wherein the processor is further configured to:
receive or determine a rating of a personal bond between at least two users referred to in the receive social interaction information and other sources of behavioral information; and
render the received social interaction information according to the determined personal. bond rating.

9. The mobile device of claim 1, wherein the at least one metric that is selectable by a user of the mobile device comprises at least one of:
a time since a last interaction;
a bond rating configured to reflect a strength of a personal bond between at least two users:
a proximity of one user with at least one other user;
a communication quality of past interactions; and
at least one external, non-social data-related factor.

10. The mobile device of claim 1, wherein at least some of the received social interaction information originates from the mobile device.

11. A computer server coupled to a computer network, the computer server comprising:
a network adaptor configured to communicate at least with social media data sources and other sources of behavioral data over a computer network:
a processor coupled to the network adaptor;
memory coupled to the processor, the memory storing a program that is configured to cause the processor to:
receive social interaction information from at least one remote computing device over the computer network;
rank the received social interaction information according to at least one metric that is selectable by a user of a computing device coupled to the computer server over the computer network; and
send the ranked social interaction information to the computing device to be rendered on a display thereof such that higher-ranked social interaction information is displayed closer to a center of concentric shapes rendered on the display of the computing device than is comparatively lower-ranked social interaction information.

12. The computer server of claim Ii. wherein the social interaction information sent to the computing device of the user to be rendered on the display thereof comprises graphic representations of social media users that are ranked and rendered on the display such that the graphic representations of social media users that have interacted with the user of the computing device more recently are rendered closer to the center of the concentric shapes than are the graphic representations of social media users that have interacted with the user of the computing device comparatively less recently.

13. The computer server of claim 11, wherein the processor is further configured to rank the received social interaction information according to two or more metrics.

14. The computer server of claim 13, wherein the processor is further configured to associate a user-selectable weight coefficient to each of the two or more metrics, thereby enabling the user to influence a ranking and rendering of the social interaction information on the concentric shapes on the display.

15. The computer server of claim 11, wherein the processor is further configured to rank the social interaction information for rendering on the display as if the user of the computing device were at the center of the concentric shapes.

16. The computer server of claim 11, wherein the processor is further configured to rank the social interaction information for rendering on the display as if a social media user other than the user of the computing device were at the center of the concentric shapes.

17. The computer server of claim 11, further comprising enabling, animation such that the social interaction information is rendered dynamically on the display of the computing device and such that additional information is selectively and dynamically made available on each of the social media users whose graphic representations are rendered on the display.

18. The computer server of claim 11, wherein the processor is further configured to:
determine a rating of a personal bond between at least two users referred to in the receive social interaction information and other sources of behavioral data.; and
rank the received social interaction information according to the determined personal bond rating.

19. The computer server of claim 11, wherein the at least one metric that s :selectable by a user of the computing device comprises at least one of
a time since a last interaction;
a bond rating configured to reflect a strength of a personal bond between at least two social. media users:
a proximity of one user with at least one other user;
a communication quality of past interactions; and
at least one external, non-social data-related factor.

20. The computer server of claim 11, wherein at least some of the received social. interaction information originates from the mobile device.

21. A computer-implemented method, comprising;
receiving at least one user-selectable metric from a user of a computing device coupled to a computer network, the at least one user-selectable metric at least influencing a manner in which a ranking of social interaction information is to be determined;
receiving the social interaction information from at least one remote computing device over the computer network;
determining the ranking of the received social interaction information according to the at least one user-selectable metric received from the user of the computing device;
configuring the ranked social interaction information to be rendered on a display of the computing, device such that higher-ranked social interaction information is displayed closer to a center of concentric shapes also rendered on the display of the computing device than is comparatively lower-ranked social interaction information; and
sending the configured ranked social interaction information to the computing device of the user over the computer network to be rendered on the display thereof along with the concentric shapes.

22. The computer-implemented method of claim 21, wherein the configured ranked social interaction information sent to the computing device to be rendered on the display thereof comprises graphic representations of social media users that are ranked and rendered on the display such that the graphic representations of social media users that have interacted with the user of the computing device more recently are rendered closer to the center of the concentric shapes than are the graphic representations of social media users that have interacted with the user of the computing device comparatively less recently.

23. The computer-implemented method of claim 21, further comprising determining the ranking of the received social interaction information according to two or more user-selectable metrics.

24. The computer-implemented method of claim 23, further comprising associating a user-selectable weight coefficient to each of the two or more user-selectable metrics, thereby enabling the user to further influence the determination of the ranking of the social interaction information and the rendering thereof on the concentric shapes on the display.

25. The computer-implemented method of claim 21, wherein determining the ranking comprises ranking the social interaction information for rendering on the display as if the user of the computing device were at the center of the concentric shapes.

26. The computer-implemented method of claim 21, wherein determining, the ranking comprises ranking the social interaction information for rendering on the display as if a social media user other than the user of the computing, device were at the center of the concentric shapes.

27. The computer-implemented method of claim 21, further comprising, enabling animation such that the social interaction information may be rendered dynamically on the display of the computing, device and such that additional information is dynamically made available on each of the social media users whose graphic representations are rendered on the display during an animation.

28. The computer-implemented method of claim 21, further comprising:
determining a rating of a personal bond between at least two social media Users referred to in the receive social interaction information; and
determining a ranking of the received social interaction information according to the determined personal bond rating.

29. The computer-implemented method of claim 21, wherein the at least one metric comprises at least one of:
a time since a last interaction;
a bond rating configured to reflect a strength of a personal bond between at least two users;
a proximity of one user with at least one other user;
a communication quality of past interactions; and
at least one external, non-social data-related factor.

30. The computer-implemented method of claim 21, wherein at least some of the received social interaction information originates from the mobile device.
